(19) United States
(12) Patent Application Publication
(10) Pub. No.: US 2018/0119588 A1
(43) Pub. Date: May 3, 2018

(54) VEHICLE

(71) Applicant: TOYOTA JIDOSHA KABUSHIKI KAISHA, Toyota-shi (JP)

(72) Inventors: Takanori OTSURA, Toyota-shi (JP); Shigeaki MURATA, Nisshin-shi (JP); Masahiro KATAYAMA, Seto-shi (JP)

(73) Assignee: TOYOTA JIDOSHA KABUSHIKI KAISHA, Toyota-shi (JP)

(21) Appl. No.: 15/782,157

(22) Filed: Oct. 12, 2017

(30) Foreign Application Priority Data
Oct. 27, 2016 (JP) 2016-210805

(51) Int. Cl. F01N 3/00

(52) U.S. Cl. CPC F01N 3/005; H01M 2220/20

(57) ABSTRACT

A vehicle includes a fuel cell, and an exhaust-drain pipe configured to temporarily accumulate water and exhaust gas discharged from the fuel cell. The exhaust-drain pipe includes a drain port provided on a bottom face portion of the exhaust-drain pipe and configured to discharge water accumulated in the exhaust-drain pipe to outside the vehicle, and a division plate provided on the bottom face portion of the exhaust-drain pipe so as to extend in a direction perpendicular to the vehicle front-rear direction, and the drain port are placed on a vehicle front side relative to the division plate.

### INCORPORATION BY REFERENCE

The disclosure of Japanese Patent Application No. 2016-210805 filed on Oct. 27, 2016 including the specification, drawings and abstract is incorporated herein by reference in its entirety.

### BACKGROUND

### 1. Technical Field

The disclosure relates to a vehicle equipped with a fuel cell.

### 2. Description of Related Art

In recent years, a vehicle equipped with a fuel cell has been put to practical use. The fuel cell generates a necessary electric power by reacting, via an electrolyte membrane, fuel gas such as hydrogen supplied to an anode side of a fuel cell stack with oxidation gas (e.g., air) including oxygen and supplied to a cathode side. The used fuel gas and the used oxidation gas after the reaction are discharged as exhaust gas to outside the fuel cell stack, together with water, which is a reaction product. The water thus discharged outside the fuel cell stack is temporarily accumulated with the exhaust gas, and then discharged outside the vehicle.

For example, the fuel cell system disclosed in Japanese Patent Application Publication No. 2008-262735 (JP 2008-262735 A) is configured such that a drain port is provided in a water storage portion in which water discharged from a fuel cell is accumulated, and a discharge valve is disposed on a downstream side relative to the drain port. Based on an acceleration speed of the water storage portion, it is determined whether or not the water in the water storage portion is placed at a position where the water is dischargeable from the discharge port, and opening of the discharge valve is controlled based on its determination result.

### SUMMARY

The fuel cell system disclosed in JP 2008-262735 A controls the opening of the discharge valve based on the acceleration speed of the water storage portion. Accordingly, there is such a possibility that, at the time of acceleration running of a vehicle, the water in the water storage portion is discharged outside the vehicle from the drain port. However, at the time of acceleration running of the vehicle, there is such a possibility that the water discharged outside the vehicle from the drain port is scattered to a neighboring vehicle or pedestrian due to an action of an inertia force in a reverse direction to a running direction.

The disclosure provides a technique that is able to restrain water discharged outside a vehicle from being scattered to a neighboring vehicle or pedestrian, in terms of a vehicle equipped with a fuel cell.

A vehicle according to one aspect of the disclosure includes a fuel cell, and an exhaust-drain pipe configured to temporarily accumulate water and exhaust gas discharged from the fuel cell, wherein: the exhaust-drain pipe includes a drain port provided on a bottom face portion of the exhaust-drain pipe and configured to discharge the water accumulated in the exhaust-drain pipe to outside the vehicle, and a division plate provided on the bottom face portion of the exhaust-drain pipe so as to extend in a direction perpendicular to the vehicle front-rear direction; and the drain port is placed on a vehicle front side relative to the division plate.

The aspect of the disclosure yields such an effect that, in the vehicle equipped with the fuel cell, water discharged outside the vehicle is restrained from being scattered to a neighboring vehicle or pedestrian.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a transparent side view illustrating an exemplary overall configuration of a vehicle according to Embodiment 1;

FIG. 2A is a side sectional view illustrating an exemplary configuration of an exhaust-drain pipe according to Embodiment 1;

FIG. 2B is a top sectional view illustrating an exemplary configuration of the exhaust-drain pipe according to Embodiment 1;

FIG. 3 is a transparent side view illustrating an example of a state of water at the time of acceleration running of the vehicle in the exhaust-drain pipe of the vehicle of FIG. 1;

FIG. 4A is a side sectional view illustrating an example of a state of water at the time of acceleration running of the vehicle in the exhaust-drain pipe of FIG. 2A;

FIG. 4B is a top sectional view illustrating an example of a state of water at the time of acceleration running of the vehicle in the exhaust-drain pipe of FIG. 2B;

FIG. 5 is a transparent side view illustrating an example of a state of water at the time of deceleration running of the vehicle in the exhaust-drain pipe of the vehicle of FIG. 1;

FIG. 6A is a side sectional view illustrating an example of a state of water at the time of deceleration running of the vehicle in the exhaust-drain pipe of FIG. 2A;

FIG. 6B is a top sectional view illustrating an example of a state of water at the time of deceleration running of the vehicle in the exhaust-drain pipe of FIG. 2B;

FIG. 7 is a side sectional view illustrating an example of a state of water at the time of constant-speed running of the vehicle in the exhaust-drain pipe of FIG. 2A;

FIG. 8 is a side sectional view illustrating an example of a state of water at the time of vehicle stop in the exhaust-drain pipe of FIG. 2A;

FIG. 9A is a side sectional view illustrating an exemplary configuration of an exhaust-drain pipe according to Embodiment 2;

FIG. 9B is a top sectional view illustrating an exemplary configuration of the exhaust-drain pipe according to Embodiment 2;

FIG. 10A is a side sectional view illustrating an example of a state of water at the time of acceleration running of a vehicle in the exhaust-drain pipe of FIG. 9A;

FIG. 10B is a top sectional view illustrating an example of a state of water at the time of acceleration running of the vehicle in the exhaust-drain pipe of FIG. 9B;

FIG. 11A is a side sectional view illustrating an example of a state of water at the time of deceleration running of the vehicle in the exhaust-drain pipe of FIG. 9A;

FIG. 11B is a top sectional view illustrating an example of a state of water at the time of deceleration running of the vehicle in the exhaust-drain pipe of FIG. 9B;

FIG. 12 is a side sectional view illustrating an example of a state of water at the time of constant-speed running of the vehicle in the exhaust-drain pipe of FIG. 9A;

FIG. 13 is a side sectional view illustrating an example of a state of water at the time of vehicle stop in the exhaust-drain pipe of FIG. 9A; and

FIG. 14 is a side sectional view illustrating a modified exemplary configuration of the exhaust-drain pipe according to Embodiment 1.

### DETAILED DESCRIPTION OF EMBODIMENTS

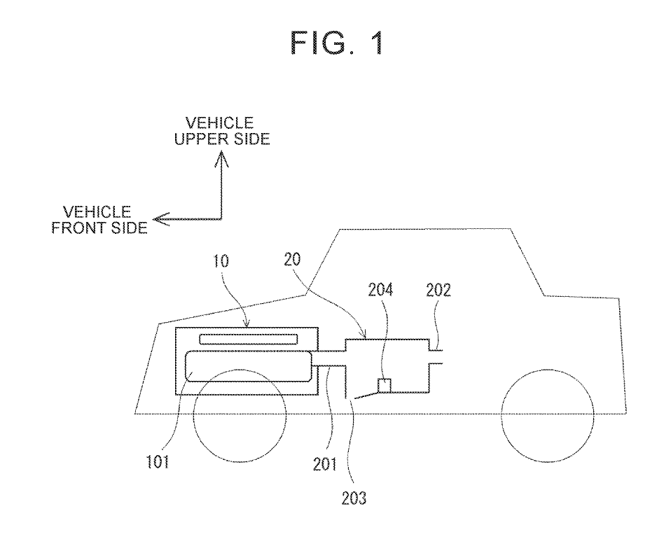

With reference to drawings, the following describes embodiments of the disclosure. The following description and drawings are omitted or simplified appropriately for clarification of the description. Further, in each of the drawings, the same element has the same reference sign, and a redundant description is omitted as needed.

<Embodiment 1> A configuration of Embodiment 1 is described. FIG. 1 is a transparent side view illustrating an exemplary overall configuration of a vehicle according to Embodiment 1. Note that FIG. 1 illustrates only constituents related to Embodiment 1 and the other constituents are not illustrated herein. Further, for easy understanding of the configuration, FIG. 1 does not illustrate water W in an exhaust-drain pipe 20.

A vehicle according to Embodiment 1 is a vehicle equipped with a fuel cell system 10 so as to run with an electric power generated by a fuel cell stack 101 in a fuel cell system 10 as a power source. The vehicle in Embodiment 1 includes the fuel cell system 10 and the exhaust-drain pipe 20.

The fuel cell system 10 includes the fuel cell stack 101 provided on a vehicle front side. The fuel cell stack 101 is an example of a fuel cell. The fuel cell stack 101 generates a necessary electric power by reacting, via an electrolyte membrane, fuel gas such as hydrogen supplied to an anode side with oxidation gas (e.g., air) including oxygen and supplied to a cathode side. Note that the electric power generated by the fuel cell stack 101 is supplied to a motor (not shown) that drives driving wheels of the vehicle.

The used fuel gas and the used oxidation gas after the reaction in the fuel cell stack 101 are discharged as exhaust gas from a vehicle rear side to outside the fuel cell stack 101 together with water W, which is a reaction product.

The exhaust-drain pipe 20 is provided on the vehicle rear side relative to the fuel cell system 10, and configured such that the exhaust gas and the water W discharged outside from the fuel cell stack 101 is temporarily accumulated and then discharged outside the vehicle. The exhaust-drain pipe 20 has a generally rectangular solid shape.

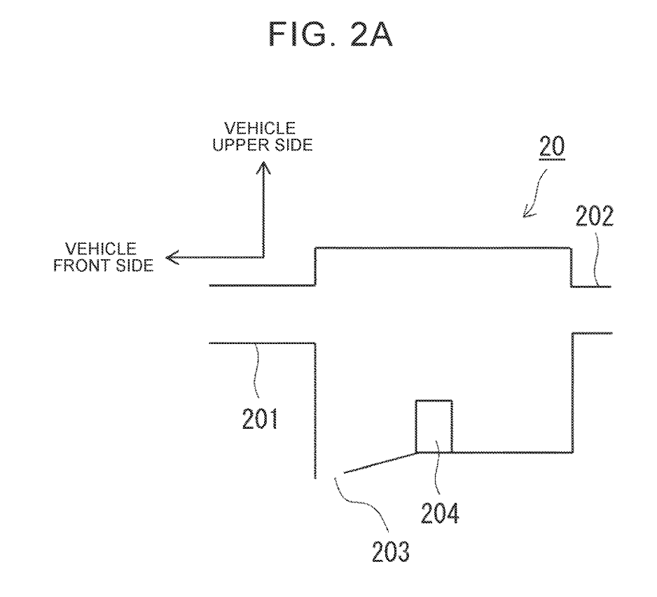

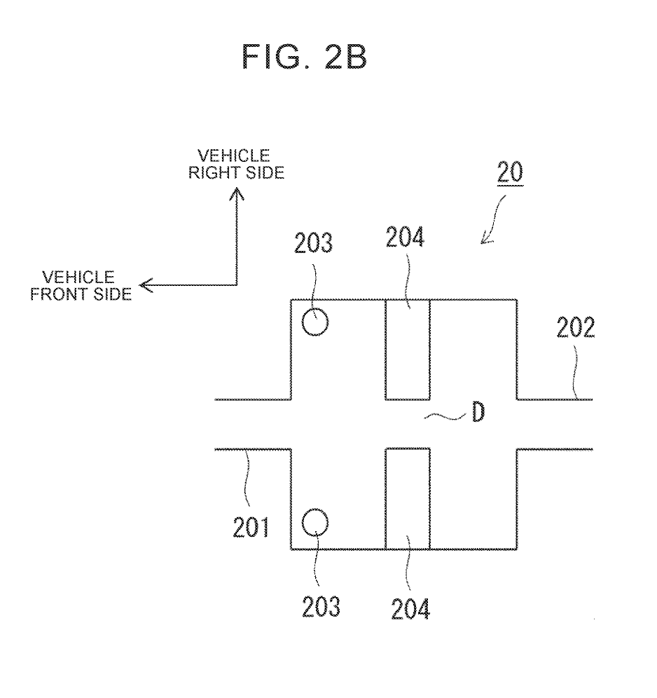

Here, a configuration of the exhaust-drain pipe 20 according to Embodiment 1 will be described in detail. FIGS. 2A and 2B illustrate an exemplary configuration of the exhaust-drain pipe 20 according to Embodiment 1. FIG. 2A is a side sectional view, and FIG. 2B is a top sectional view. Note that, for easy understanding of the configuration, FIGS. 2A and 2B do not illustrate the water W in the exhaust-drain pipe 20. The exhaust-drain pipe 20 according to Embodiment 1 includes an exhaust pipe 201, an exhaust port 202, a drain port 203, and a division plate 204.

The exhaust pipe 201 is connected to the fuel cell stack 101 on a side face portion of the exhaust-drain pipe 20 on a vehicle front side, so as to introduce the exhaust gas and the water W discharged outside from the fuel cell stack 101 into the exhaust-drain pipe 20. The exhaust gas and the water W are temporarily accumulated inside the exhaust-drain pipe 20.

The exhaust port 202 is provided in a side face portion of the exhaust-drain pipe 20 on the vehicle rear side. The exhaust gas accumulated in the exhaust-drain pipe 20 is discharged outside the vehicle from the vehicle rear side. The drain port 203 is provided on a bottom face portion of the exhaust-drain pipe 20, and the water W accumulated in the exhaust-drain pipe 20 is discharged outside the vehicle from the bottom face. The drain port 203 has a hole-shape, and two drain ports 203 are provided.

The division plate 204 is provided on the bottom face portion of the exhaust-drain pipe 20, and extends in a direction (a vehicle right-left direction; the same shall apply hereinafter) generally perpendicular to a vehicle front-rear direction. Two division plates 204 are provided. The two division plates 204 are arranged with a predetermined gap D along the direction generally perpendicular to the vehicle front-rear direction. Further, one of the two division plates 204 extends to one end in the direction generally perpendicular to the vehicle front-rear direction, and the other one extends to the other end in the direction generally perpendicular to the vehicle front-rear direction.

The drain ports 203 are placed on a bottom face portion on the vehicle front side, partitioned by the division plates 204, in the bottom face portion of the exhaust-drain pipe 20. That is, the drain ports 203 are placed on the vehicle front side relative to the division plates 204. Further, two drain ports 203 are placed around both ends in the direction generally perpendicular to the vehicle front-rear direction.

Further, an inclined portion inclined downward from the division plates 204 to the drain ports 203 is formed on the bottom face portion on the vehicle front side, partitioned by the division plates 204, in the bottom face portion of the exhaust-drain pipe 20. That is, the drain ports 203 are placed in an inclined distal end of the inclined portion.

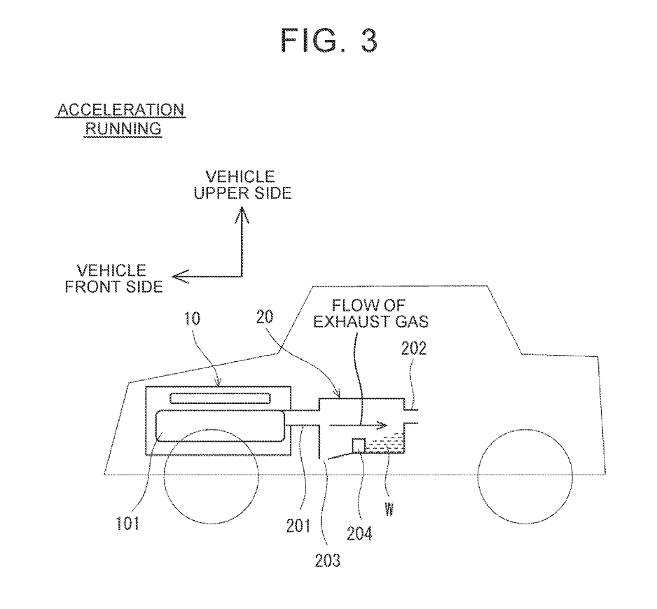

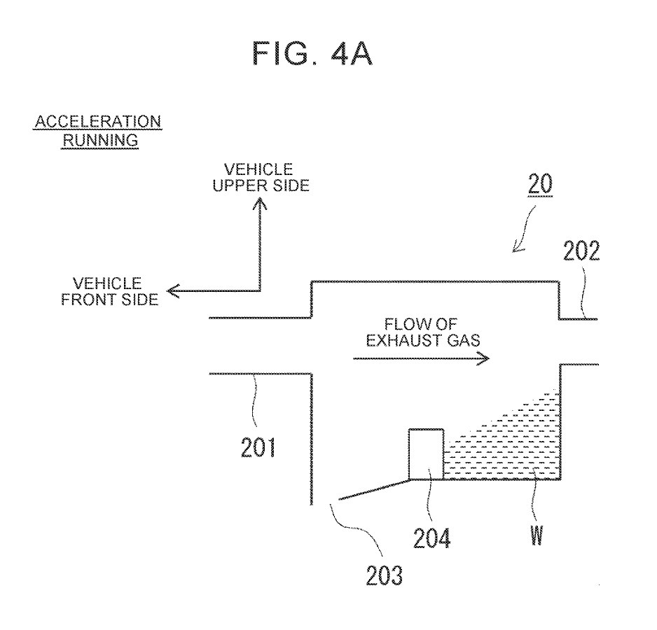

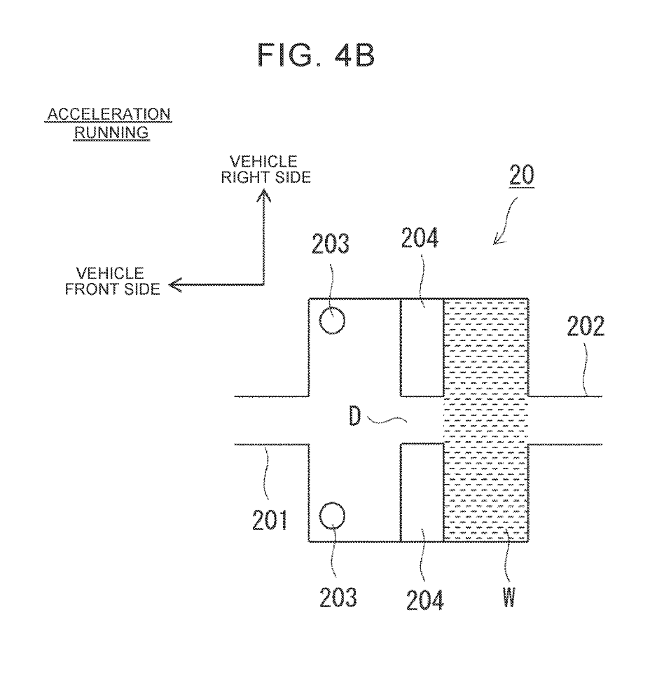

The following descries a state of the water W in the exhaust-drain pipe 20 of Embodiment 1. (1) Acceleration Running First described is a state of the water W in the exhaust-drain pipe 20 at the time of acceleration running of the vehicle. FIGS. 3, 4A, and 4B illustrate an example of the state of the water W at the time of acceleration running of the vehicle in the exhaust-drain pipe 20 similar to one in FIGS. 1, 2A, and 2B.

At the time of acceleration running of the vehicle, a flow speed of the exhaust gas directed toward the vehicle rear side increases inside the exhaust-drain pipe 20 due to an action of an inertia force in a reverse direction to a running direction, so that the water W is pressed against the vehicle rear side due to the flow of the exhaust gas. Further, the two division plates 204 prevent the water W thus pressed against the vehicle rear side from moving toward the vehicle front side. This restrains the water W from being discharged from the drain ports 203 at the time of acceleration running of the vehicle.

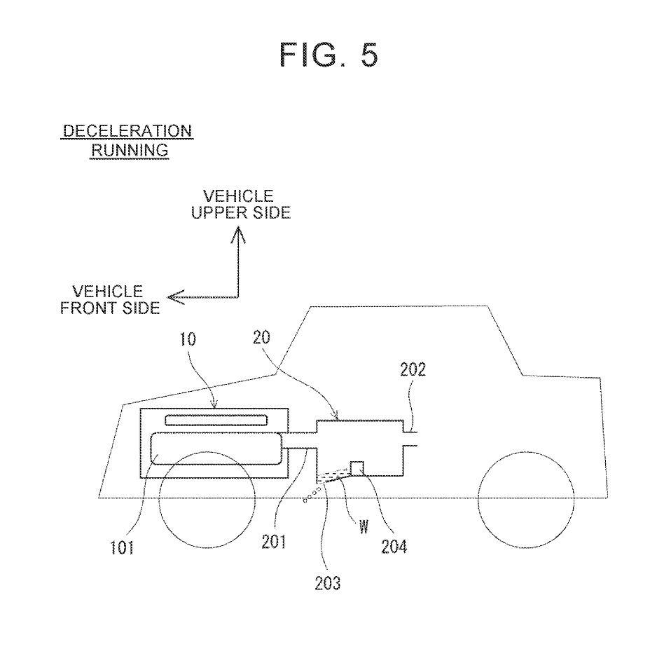

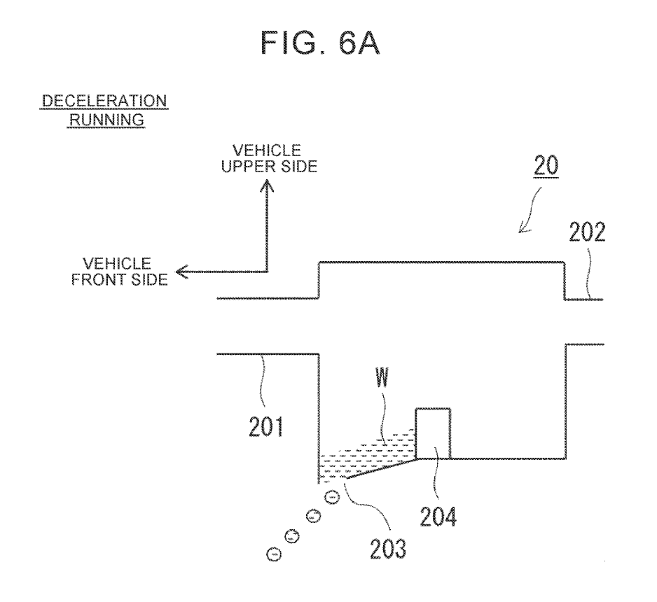

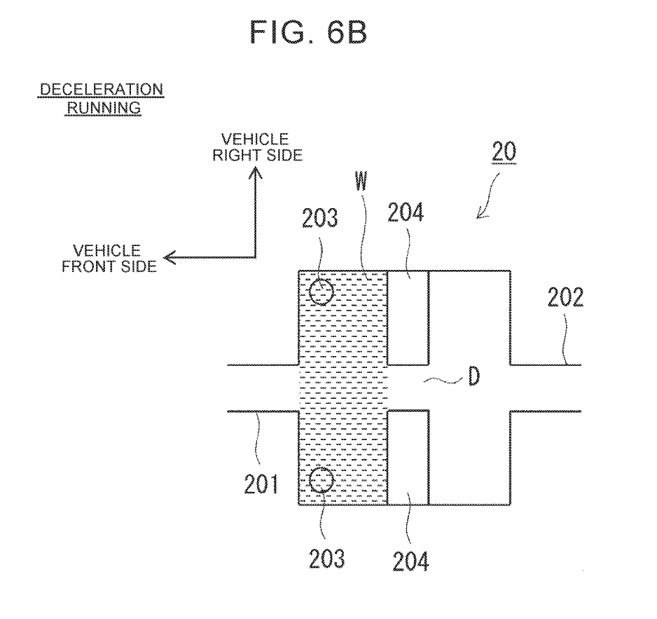

(2) Deceleration Running Next described is a state of the water W in the exhaust-drain pipe 20 at the time of deceleration running of the vehicle. FIGS. 5, 6A, and 6B illustrate an example of the state of the water W at the time of deceleration running of the vehicle in the exhaust-drain pipe 20 similar to one in FIGS. 1, 2A, and 2B.

At the time of deceleration running of the vehicle, the flow speed of the exhaust gas directed toward the vehicle rear side largely decreases inside the exhaust-drain pipe 20 due to an action of an inertia force in the same direction as the running direction, so that the action of the exhaust gas to the water W decreases. Accordingly, the water W on the vehicle rear side passes through the gap D provided between the two division plates 204 or jumps over the two division plates 204 due to the action of the inertia force in the same direction as the running direction, so as to move to the vehicle front side, and then, the water W is discharged from the drain ports 203 to the vehicle front side. As such, at the time of deceleration running of the vehicle, the water W is discharged from the drain ports 203 to the vehicle front side, thereby restraining the water W from being scattered to a neighboring vehicle or pedestrian.

As described above, according to Embodiment 1, the exhaust-drain pipe 20 includes, on its bottom face portion, the drain ports 203 for discharging the water W accumulated in the exhaust-drain pipe 20 to outside the vehicle, and the two division plates 204 extending in the direction generally perpendicular to the vehicle front-rear direction, and the drain ports 203 are placed on the vehicle front side relative to the division plates 204. Further, the two division plates 204 are arranged with the predetermined gap D provided therebetween.

Accordingly, at the time of acceleration running of the vehicle, the water W inside the exhaust-drain pipe 20 is pressed against the vehicle rear side due to the action of the inertia force in the reverse direction to the running direction and is prevented by the two division plates 204 from moving toward the vehicle front side. This accordingly restrains the water W from being discharged from the drain ports 203.

Further, at the time of deceleration running of the vehicle, the water W in the exhaust-drain pipe 20 passes through the gap D provided between the two division plates 204 or jumps over the two division plates 204 due to the action of the inertia force in the same direction as the running direction, so as to move from the vehicle rear side to the vehicle front side, and then, the water W is discharged from the drain ports 203 to the vehicle front side.

As such, at the time of acceleration running of the vehicle, the water W is restrained from being discharge from the drain ports 203, and at the time of deceleration running of the vehicle, the water W is discharged from the drain ports 203 to the vehicle front side, thereby making it possible to restrain the water W discharged outside the vehicle from being scattered to a neighboring vehicle or pedestrian.

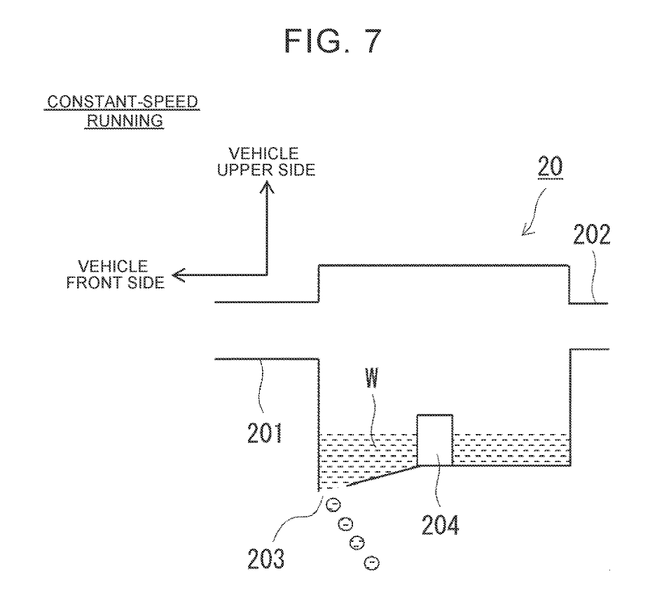

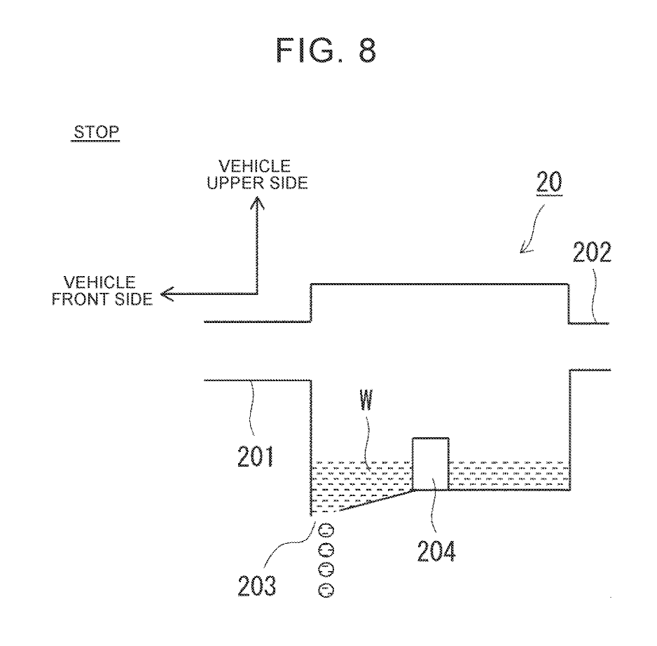

Note that Embodiment 1 is described on the premise that the vehicle performs the deceleration running after the acceleration running, but the vehicle may perform constant-speed running between the acceleration running and the deceleration running. However, as illustrated in FIG. 7, at the time of constant-speed running of the vehicle, the water W in the exhaust-drain pipe 20 does not receive the action of the inertia force, so the water W is discharged from the drain ports 203 only slightly to the vehicle rear side, and it is considered that the water W is sufficiently less likely to be scattered to a neighboring vehicle or pedestrian. Further, as illustrated in FIG. 8, at the time of stop of the vehicle, the water W in the exhaust-drain pipe 20 is discharged generally vertically downward from the drain ports 203. Accordingly, in both cases of the constant-speed running and the stop of the vehicle, it is possible to restrain the water W discharged outside the vehicle from being scattered to a neighboring vehicle or pedestrian.

<Embodiment 2> A configuration of Embodiment 2 is described. In comparison with the vehicle in Embodiment 1 described with reference to FIG. 1, a vehicle in Embodiment 2 is configured such that the exhaust-drain pipe 20 is replaced with an exhaust-drain pipe 21. On that account, the following describes only a configuration of the exhaust-drain pipe 21 of Embodiment 2.

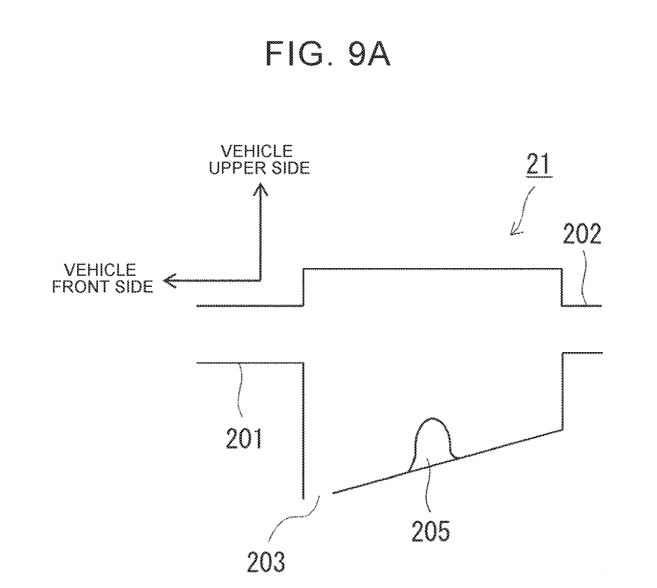

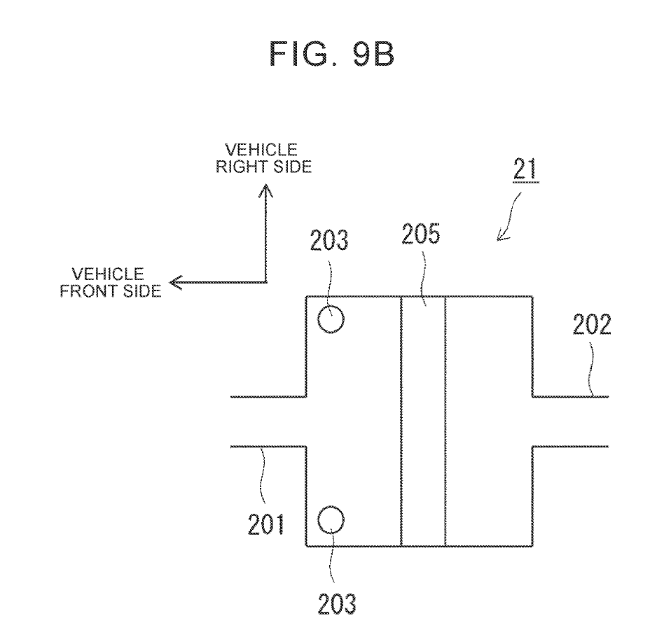

FIGS. 9A, 9B illustrate an exemplary configuration of the exhaust-drain pipe 21 according to Embodiment 2. FIG. 9A is a side sectional view and FIG. 9B is a top sectional view. Note that, for easy understanding of the configuration, FIGS. 9A and 9B do not illustrate water W in the exhaust-drain pipe 21. In comparison with the exhaust-drain pipe 20 in Embodiment 1 described with reference to FIGS. 2A and 2B, the exhaust-drain pipe 21 in Embodiment 2 is configured such that the division plates 204 are replaced with a division plate 205. The following describes differences from the exhaust-drain pipe 20 in Embodiment 1 as a configuration of the exhaust-drain pipe 21 in Embodiment 2.

The division plate 205 is provided on a bottom face portion of the exhaust-drain pipe 21, and extends in a direction (a vehicle right-left direction; the same shall apply hereinafter) generally perpendicular to a vehicle front-rear direction. Only one division plate 205 is provided so as to extend between both ends in the direction generally perpendicular to the vehicle front-rear direction. Further, a sectional shape of the division plate 205 when cut in the vehicle front-rear direction is a shape having a curved surface around an upper part.

The bottom face portion of the exhaust-drain pipe 21 is configured such that an inclined portion inclined downward from the division plate 205 toward drain ports 203 is formed in a bottom face portion, on a vehicle front side, partitioned by the division plate 205. Further, an inclined portion inclined downward toward the vehicle front side is formed in a bottom face portion on the vehicle rear side. Note that, in the example of FIGS. 9A and 9B, the inclined portions on the vehicle front side and the vehicle rear side are inclined surfaces continuous with each other, but they are not limited to this. The inclined portions on the vehicle front side and the vehicle rear side may be discontinuous inclined surfaces across the division plate 205.

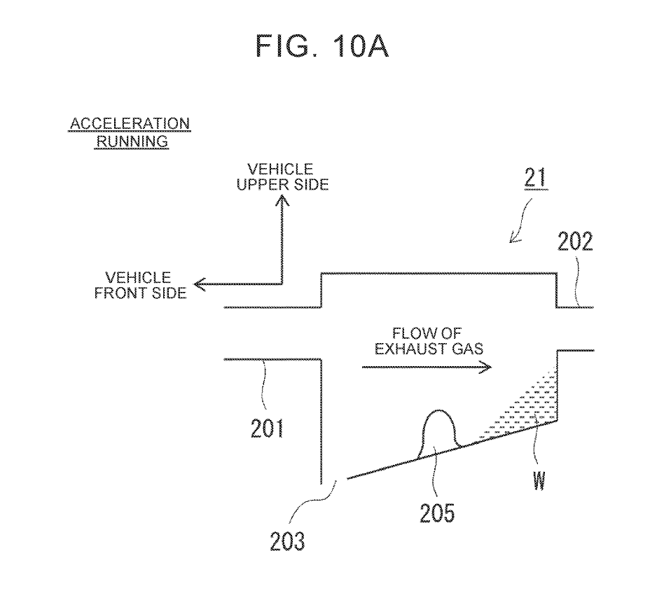

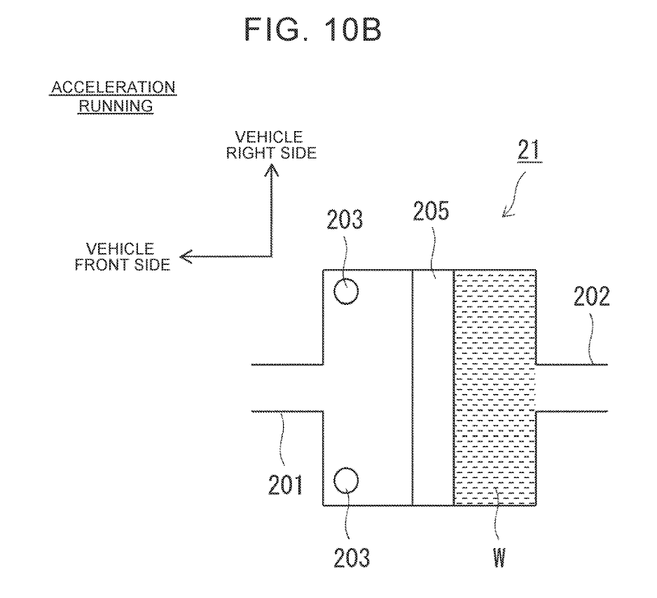

The following describes a state of water W in the exhaust-drain pipe 21 in Embodiment 2. (1) Acceleration Running First described is a state of the water W in the exhaust-drain pipe 21 at the time of acceleration running of the vehicle. FIGS. 10A and 10B illustrate an example of the state of the water W at the time of acceleration running of the vehicle in the exhaust-drain pipe 21 similar to one in FIGS. 9A and 9B.

At the time of acceleration running of the vehicle, a flow speed of exhaust gas directed toward the vehicle rear side increases inside the exhaust-drain pipe 21 due to an action of an inertia force in a reverse direction to a running direction, so that the water W is pressed against the vehicle rear side due to the flow of the exhaust gas. Further, the division plate 205 prevents the water W thus pressed against the vehicle rear side from moving toward the vehicle front side. This restrains the water W from being discharge from the drain ports 203 at the time of acceleration running of the vehicle.

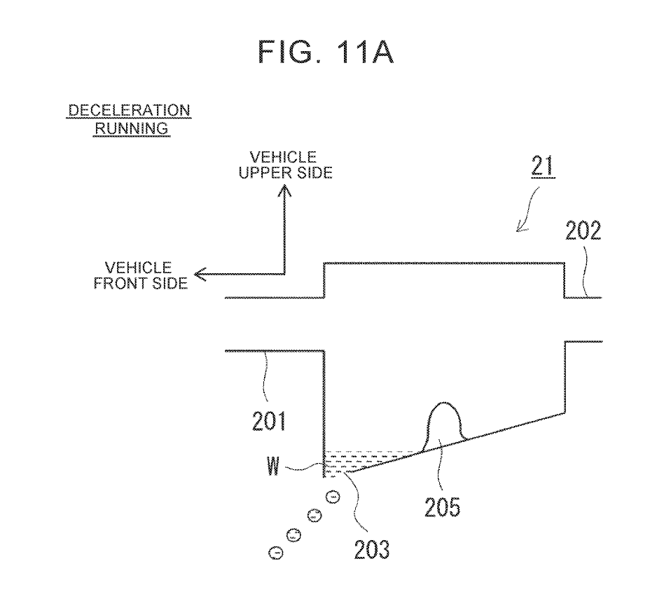

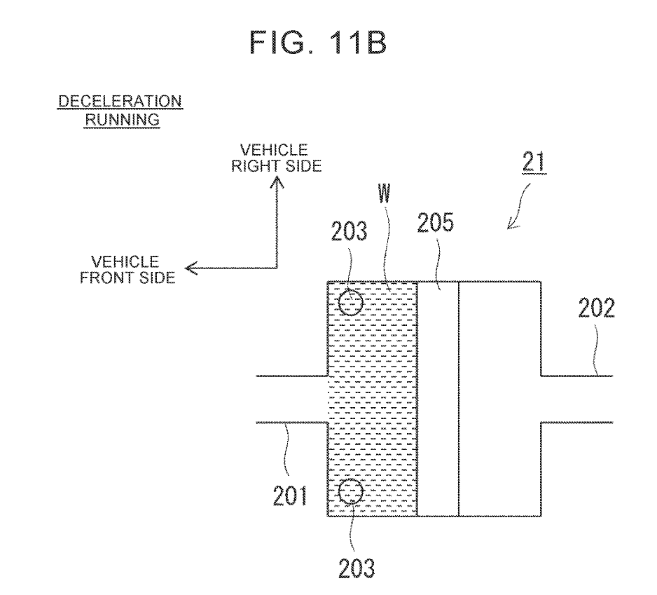

(2) Deceleration Running Next described is a state of the water W in the exhaust-drain pipe 21 at the time of deceleration running of the vehicle. FIGS. 11A and 11B illustrate an example of the state of the water W at the time of deceleration running of the vehicle in the exhaust-drain pipe 21 similar to one in FIGS. 9A and 9B.

At the time of deceleration running of the vehicle, the flow speed of the exhaust gas directed toward the vehicle rear side largely decreases inside the exhaust-drain pipe 21 due to an action of an inertia force in the same direction as the running direction, so that the action of the exhaust gas to the water W decreases. Accordingly, the water W on the vehicle rear side jumps over the division plate 205 due to the action of the inertia force in the same direction as the running direction, so as to move to the vehicle front side, and then, the water W is discharged from the drain ports 203 to the vehicle front side. At this time, since the inclined portion is formed in the bottom face portion, on the vehicle rear side, partitioned by the division plate 205 of the exhaust-drain pipe 21, and further, the division plate 205 has a curved surface around its upper part, the water W on the vehicle rear side easily moves to the vehicle front side. As such, at the time of deceleration running of the vehicle, the water W is discharged from the drain ports 203 to the vehicle front side, thereby restraining the water W from being scattered to a neighboring vehicle or pedestrian.

As described above, in Embodiment 2, the exhaust-drain pipe 21 includes, on its bottom face portion, the drain ports 203 for discharging the water W accumulated in the exhaust-drain pipe 21 to outside the vehicle, and the division plate 205 extending in the direction generally perpendicular to the vehicle front-rear direction, and the drain ports 203 are placed on the vehicle front side relative to the division plate 205. Further, a sectional shape of the division plate 205 when cut in the vehicle front-rear direction is a shape having a curved surface around its upper part. Further, the inclined portion inclined downward toward the vehicle front side is formed in the bottom face portion, on the vehicle rear side, partitioned by the division plate 205 of the exhaust-drain pipe 21.

Accordingly, at the time of acceleration running of the vehicle, the water W inside the exhaust-drain pipe 21 is pressed against the vehicle rear side due to the action of the inertia force in the reverse direction to the running direction and is prevented by the division plate 205 from moving toward the vehicle front side. This accordingly restrains the water W from being discharged from the drain ports 203.

Further, at the time of deceleration running of the vehicle, the water W in the exhaust-drain pipe 21 jumps over the division plate 205 due to the action of the inertia force in the same direction as the running direction, so as to move from the vehicle rear side to the vehicle front side, and then, the water W is discharged from the drain ports 203 to the vehicle front side. At this time, since the inclined portion is formed in the bottom face portion, on the vehicle rear side, partitioned by the division plate 205 of the exhaust-drain pipe 21, and further, the division plate 205 has a curved surface around its upper part, the water W easily moves to the vehicle front side.

Thus, at the time of acceleration running of the vehicle, the water W is restrained from being discharged from the drain ports 203, and at the time of deceleration running of the vehicle, the water W is discharged from the drain ports 203 to the vehicle front side, thereby making it possible to restrain the water W discharged outside the vehicle from being scattered to a neighboring vehicle or pedestrian.

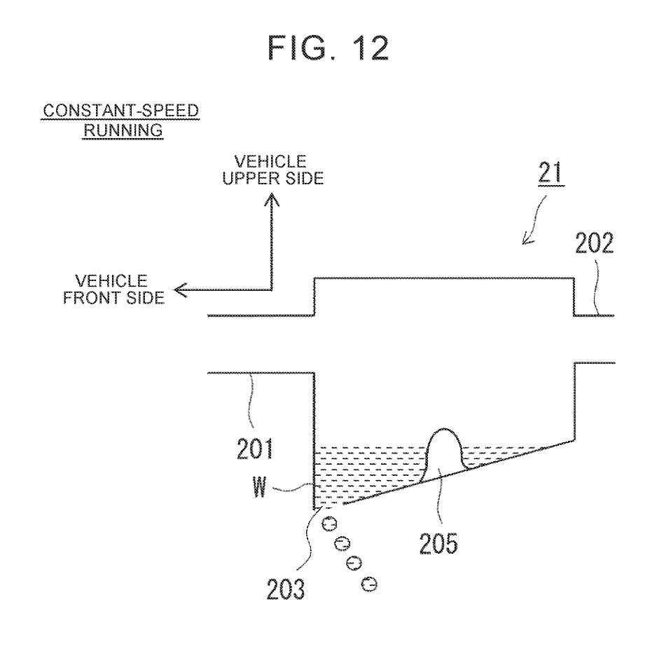

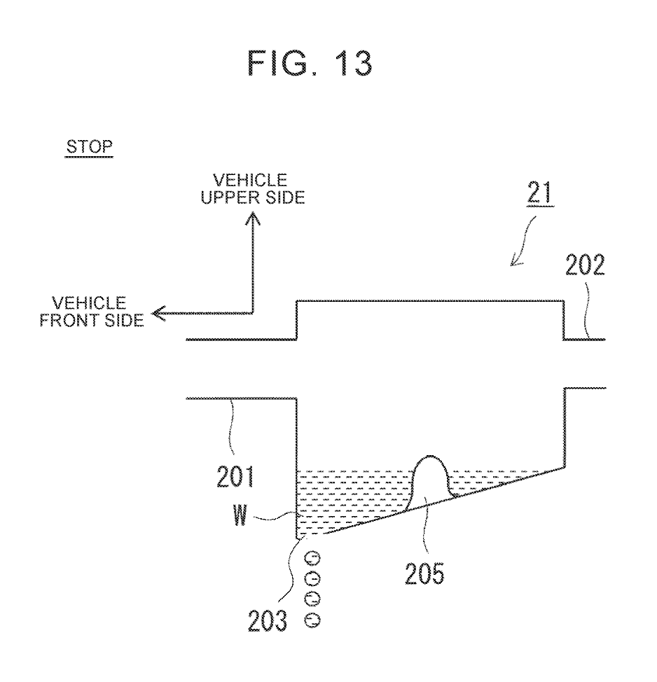

Note that Embodiment 2 is described on the premise that the vehicle performs deceleration running after acceleration running, but the vehicle may perform constant-speed running between the acceleration running and the deceleration running. However, at the time of constant-speed running of the vehicle, the water W in the exhaust-drain pipe 21 does not receive the action of the inertia force as illustrated in FIG. 12, so the water W is discharged from the drain ports 203 only slightly to the vehicle rear side, and it is considered that the water W is sufficiently less likely to be scattered to a neighboring vehicle or pedestrian. Further, as illustrated in FIG. 13, at the time of stop of the vehicle, the water W in the exhaust-drain pipe 21 is discharged generally vertically downward from the drain ports 203. Accordingly, in both cases of the constant-speed running and the stop of the vehicle, it is possible to restrain the water W discharged outside the vehicle from being scattered to a neighboring vehicle or pedestrian.

Note that the disclosure is not limited to the above embodiments, and various modifications can be made within a range that does not deviate from the gist of the disclosure. For example, a part of or all of Embodiments 1, 2 described above may be used in combination.

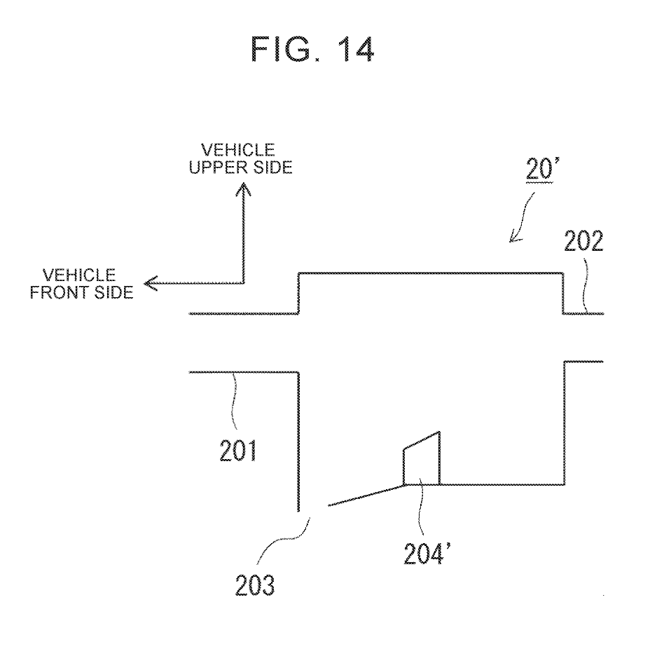

Further, in Embodiment 1, a sectional shape of the division plate 204 included in the exhaust-drain pipe 20 when cut in the vehicle front-rear direction is a square shape, but is not limited to this and may be other sectional shapes. For example, like an exhaust-drain pipe 20′ illustrated in FIG. 14, a division plate 204′ having a pentagonal sectional shape when cut in the vehicle front-rear direction may be provided. Since the sectional shape of the division plate 204′ is a pentagon, it is possible to reduce a pressure loss at the time when the water W passes over the division plate 204′.

Further, in Embodiment 1, the exhaust-drain pipe 20 includes two division plates 204. However, the number of division plates 204 should be the plural number, but is not limited to two. The plurality of division plates 204 should be arranged with a predetermined gap along the direction generally perpendicular to the vehicle front-rear direction.

Further, in Embodiment 2, the sectional shape of the division plate 205 included in the exhaust-drain pipe 21, when cut along the vehicle front-rear direction, has a curved surface around the upper parts on both the vehicle front side and the vehicle rear side, but is not limited to this. It is considered that the water W on the vehicle rear side easily jumps over the division plate 205 even if the sectional shape of the division plate 205 has a curved surface only around the upper part on the vehicle rear side, for example, and therefore, the division plate 205 may have such a sectional shape. Further, the sectional shape of the division plate 205 is not to them, but may be other sectional shapes as long as the water W on the vehicle rear side easily jumps over the division plate 205.

What is claimed is:

1. A vehicle comprising:
a fuel cell; and
an exhaust-drain pipe configured to temporarily accumulate water and exhaust gas discharged from the fuel cell, wherein
the exhaust-drain pipe includes a drain port provided on a bottom face portion of the exhaust-drain pipe and configured to discharge the water accumulated in the exhaust-drain pipe to outside the vehicle, and a division plate provided on the bottom face portion of the exhaust-drain pipe so as to extend in a direction perpendicular to a vehicle front-rear direction; and
the drain port is placed on a vehicle front side relative to the division plate.

2. The vehicle according to claim 1, wherein:
the exhaust-drain pipe includes a plurality of division plates; and
the plurality of division plates is arranged with a predetermined gap along the direction perpendicular to the vehicle front-rear direction.

3. The vehicle according to claim 2, wherein
an inclined portion inclined downward from the division plates toward the drain port is formed in a part of the bottom face portion of the exhaust-drain pipe on the vehicle front side, the part being partitioned by the division plates.

4. The vehicle according to claim 1, wherein
a sectional shape of the division plate when cut in the vehicle front-rear direction is a shape having a curved surface around an upper part of the division plate.

5. The vehicle according to claim 4, wherein
an inclined portion inclined downward from the division plate toward the drain port is formed in a part of the bottom face portion of the exhaust-drain pipe on the vehicle front side, the part being partitioned by the division plate; and
an inclined portion inclined downward toward the vehicle front side is formed in a part of the bottom face portion of the exhaust-drain pipe on a vehicle rear side, the part being partitioned by the division plate.
